(19) United States
(12) Patent Application Publication
(10) Pub. No.: US 2014/0353283 A1
(43) Pub. Date: Dec. 4, 2014

(54) OPTICAL SCREENING SYSTEM

(71) Applicant: Aselsan Elektronik Sanayi ve Ticaret Anonim Sirketi, Ankara (TR)

(72) Inventors: Ozcan Kahramangil, Ankara (TR); Alp Eren Sinan Ozhan, Ankara (TR); Caner Durucan, Ankara (TR); Hakan Yavas, Ankara (TR); Cemile Duygu Ozturk Selcuk, Ankara (TR)

(21) Appl. No.: 14/362,136

(22) PCT Filed: Dec. 3, 2012
(86) PCT No.: PCT/IB2012/056914

§ 371 Date: Jun. 2, 2014

(30) Foreign Application Priority Data
Dec. 2, 2011 (TR) 2011/11968

(51) Int. Cl. B23H 9/00

(52) U.S. Cl. CPC B23H 9/001
USPC 219/68

(57) ABSTRACT

The present invention relates to rendering electro-optical systems (thermal camera, camera, binoculars, sighting device, etc.) unusable (optical darkening). The inventive optical screening system, which prevents reuse of the electro-optical devices by destructing optical components thereof, essentially comprises at least one optical group consisting of the optical components of the electro-optical system, at least one destructive unit which destructs the optical group, at least one triggering unit which activates the destructive unit, at least one management center which issues a command to the triggering unit to start optical screening.

### FIELD OF THE INVENTION

The present invention relates to rendering electro-optical systems (thermal camera, camera, binoculars, sighting device, etc.) dysfunctional/unusable by screening the optical paths (optical screening).

### BACKGROUND OF THE INVENTION

Today, electro-optical systems are widely used in military both in air, land and sea vehicles and in handheld systems. These systems which are used for performing different functions provide various advantages to the user. However, a problem which especially occurs in use of handheld systems is the possibility of the electro-optical systems to be captured by unwanted persons or groups. In these cases unwanted persons or groups make use of the advantages provided by the electro-optical systems.

There are various approaches for preventing persons or groups capturing an electro-optical system from making use of this system. In one of these approaches, electronic elements provided in an electro-optical system are rendered unusable. This brings along a problem such as repairing or replacing the destructed electronic components in the electro-optical systems and thereby making the device usable again.

In order to prevent unintended and unwanted users, who capture an electro-optical device, from making use of the device, to render the optical components unusable is a more effective method. However in the current knowledge, there is no use of optical screening for this purpose.

The European patent document no. EP 0823653, an application in the state of the art, discloses a component with optical properties having variable transmission and absorption between electrochromic or photochromic type polymer films with diffusion of liquid crystal.

The Japanese patent document no. JP 2005173265, an application in the state of the art, discloses use of a liquid that prevents light between two optical materials.

### SUMMARY OF THE INVENTION

The present invention provides a system which makes the optical components of the electro-optical systems, which are more difficult to make usable again than the electronic components, unusable or dysfunctional.

### DETAILED DESCRIPTION OF THE INVENTION

The inventive optical screening system, which prevents reuse of the electro-optical devices by destructing optical components thereof, essentially comprises
at least one optical group consisting of the optical components of the electro-optical system,
at least one destructive unit which renders the optical group unusable,
at least one triggering unit which activates the destructive unit,
at least one management center which issues a command to the triggering unit to start optical darkening.

The optical group is in the optical path of the device. This component is comprised of one or more elements, which receive visible light that is far away or very little, or infrared lights that are close by, and bring the light to a visible level and generate image.

When the destructive unit is activated, it destructs or changes the properties of the optical group. The optical group whose properties are changed fails to perform its function. The electro-optical device having an optical component which fails to perform its function becomes unusable.

The destructive unit is activated by the triggering unit. Upon the command for starting optical screening, which reaches the triggering unit wirelessly, the triggering unit activates the destructive unit.

Data from the management center for starting optical screening is sent to the triggering unit wirelessly.

The management center is responsible for delivering the command of starting optical screening to the triggering unit. The command is transmitted to the triggering unit wirelessly and transferred by the triggering unit to the destructive unit.

In a preferred embodiment of the invention, multiple layer thin film coated substrate having optical function such as anti-reflection AR or high-reflection HR is used as the optical group and an electrode assembly is used as the destructive unit. Electrodes are formed on two sides of the optical group by performing metal coating such that they will not be placed on the optical path or they will not affect the optical function. The triggering unit activates the destructive unit with the command it receives from the management center wirelessly. When the destructive unit, which is an electrode assembly, is activated by the triggering unit, the electrodes connected to the optical group comprising optic film thereon enable electric voltage to be applied on the optical group. The optical element on which voltage is applied starts to get heated. Since the substrate and the multiple layer thin films thereon forming the optical group have different expansion coefficients, a mechanical tension results because of the heat. Due to this tension, cracks form on the coating on the optical film. The said cracks deform the transmission/reflectivity properties of the optical coating and thus the electro-optical system becomes unusable and is darkened irreversibly.

In another preferred embodiment of the invention, polymers showing degradation/melting at temperatures of 70-150° C. such as triphenyl phosphate, polystyrene and the like are used in the optical group structure, and a metal oxide thin film layer coated with a thin film and an electrode assembly are used as the destructive unit. The metal oxide thin film layer is coated at thickness levels below one micrometer in such a way that it will cover the surface of the substrate homogeneously and will resist in the range of 0.5-100 kOhm. Electrodes are formed on two sides of the metal oxide thin film layer by performing metal coating in such a way that they will not affect the optical function. Polymeric layer having relatively low melting/degradation temperature—such as polystyrene, triphenyl phosphate or derivatives thereof—is coated on top of the metal coating. Electrodes are formed on two sides of the optical group by performing metal coating such that they will not be placed on the optical path. When the destructive unit, which is an electrode assembly, is activated by the triggering unit, the electrodes, which are connected to the optical group made of low melting temperature materials and formed on metal oxide thin film, enable electric voltage to be applied on the optical group. The optical group on which voltage is applied starts to get heated. The metal oxide thin film layer gets heated up to the temperature of 150° C. and undergoes phase change when the polymeric layer formed thereon reaches melting/degradation temperature. The related phase change is directly associated with the chemical properties of the polymeric layer. For instance, while the coatings produced using polystyrene chemical start to darken at temperatures of 100-110° due to the impact of the cross linking of monomer groups, triphenyl phosphate rapidly melts at lower temperatures.

Optical group undergoes phase change when it reaches the melting temperature of the material it is made of The optical group which has undergone phase change cannot perform its function on the optical path and thus the electro-optical system becomes unusable and is screened irreversibly.

In another preferred embodiment of the invention, a material, whose properties change/degrade temporarily or permanently when AgCl (silver-chloride) or ultraviolet radiation is used in the optical group structure as an optical film and/or optical window material, and at least one light emitting diode (LED), which radiates at ultraviolet band (UV), is used as the destructive unit. When the triggering unit activates the light emitting diode/diodes, the diode/diodes start to emit ultraviolet light. Transmission/reflectivity properties of the optical group elements, which are subjected to ultraviolet light, change. Thus the electro-optical system is screened and becomes unusable.

In another preferred embodiment of the invention, KBr (potassium-Bromide) material, which is soluble in moisture and/or water, is used in the optical group structure, and water within a sealed housing is used as the destructive unit. KBr is a material which has high light transmission especially at visible light wavelengths. However, it rapidly dissolves and degrades in water or at environments where there is water vapor (moisture). When the triggering unit activates the housing, it releases the liquid in the housing. The liquid contacting the optical group reacts with the KBr in the structure of the optical group elements. As a result of reaction of KBr material with the liquid, structure of the optical group degrades and the optical group cannot perform its function on the optical path. Thus, the electro-optical system becomes unusable and is screened irreversibly.

By means of the inventive “an optical darkening system”, if electro-optical systems used for military purposes (thermal camera, camera, sighting device, binoculars, etc.) are captured by unwanted persons or groups, the said systems can be destructed irreversibly as a counter measure. The prior art problem of possibility to make the system usable again after electro-optical systems are destructed, by replacing its pieces or producing equivalents of the deformed pieces by reverse engineering is thus eliminated. Hence by means of “an optical darkening system”, unwanted persons and groups are prevented from utilizing the systems which provide the user advantages during close contact.

Within the scope of this basic concept, it is possible to develop various embodiments of the inventive optical screening system. The invention can not be limited to the examples described herein and it is essentially as defined in the claims.

1. An optical screening system, for preventing reuse of the electro-optical devices by destructing optical components thereof, comprising: at least one optical group consisting of the optical components of the electro-optical system; at least one destructive unit for destructing the optical group; at least one triggering unit for activating the destructive unit, and at least one management center which issues a command to the triggering unit to start optical screening.

2. The optical screening system of claim 1, further comprising: the optical group, which is an optical film with anti-reflection AR or high-reflection HR coating, and the destructive unit which is an electrode assembly.

3. The optical screening system of claim 1, further comprising: an optical film and a coating on the optical film whose expansion coefficients are different from each other.

4. The optical screening system according to claim 1, further comprising polymers wherein polymers has low melting temperatures in its structure, and the destructive unit which is an electrode assembly.

5. The optical screening system of claim 1 further comprising: a destructive unit which applies electric voltage on the optical group.

6. The optical screening system of claim 5, wherein the optical film and/or the optical windows material is Agel, and the destructive unit which is a diode/diodes radiating at ultraviolet band.

7. The optical screening system of claim 1, wherein the optical group has KBr in its structure, and the destructive unit which is a sealed liquid housing.

8. The optical screening system of claim 1 wherein the destructive unit is a sealed liquid housing and the destructive unit releases the liquid therein upon receiving the command from the triggering unit.

9. The optical screening system of claim 2, further comprising an optical film and a coating on the optical film whose expansion coefficients are different from each other.

10. The optical screening system of claim 2 further comprising: a destructive unit which applies electric voltage on the optical group.

11. The optical screening system of claim 3 further comprising: a destructive unit which applies electric voltage on the optical group.

12. The optical screening system of claim 4 further comprising: a destructive unit which applies electric voltage on the optical group.

13. The optical screening system of claim 7, wherein the destructive unit is a sealed liquid housing and the destructive unit releases the liquid therein upon receiving the command from the triggering unit.
